(19) United States
(12) Patent Application Publication
(10) Pub. No.: US 2016/0084489 A1
(43) Pub. Date: Mar. 24, 2016

(54) HEAT SINK HAVING HEAT DISSIPATING FIN AND LIGHTING DEVICE

(71) Applicant: Kabushiki Kaisha Toshiba, Minato-ku (JP)

(72) Inventors: Kakeru YAMAGUCHI, Yokohama (JP); Michinobu Inoue, Yokohama (JP)

(73) Assignee: Kabushiki Kaisha Toshiba, Minato-ku (JP)

(21) Appl. No.: 14/832,204

(22) Filed: Aug. 21, 2015

(30) Foreign Application Priority Data
Sep. 24, 2014 (JP) 2014-194488

(51) Int. Cl. F21V 29/75; F21V 7/22; F28F 13/06

(52) U.S. Cl. CPC F21V 29/75; F28F 13/06; F21V 7/22

(57) ABSTRACT

A heat sink according to an embodiment includes a base plate having cutting portions, and a heat dissipating fin. The heat dissipating fin is provided perpendicularly to a principal plane of the base plate and is a member having a sectional shape in a direction horizontal to the principal plane of the base plate. The sectional shape is constant substantially in a perpendicular direction. A lighting device according to an embodiment includes the heat sink and a light emitting unit. The light emitting unit is provided on a surface of a base plate opposite to another surface of the base plate of the heat sink on which a heat dissipating fin is arranged.

### CROSS-REFERENCE TO RELATED APPLICATION

This application is based upon and claims the benefit of priority from the prior Japanese Patent Application No. 2014-194488, filed on Sep. 24, 2014, the entire contents of which are incorporated herein by reference.

### FIELD

Embodiments described herein relate generally to a heat sink having a heat dissipating fin and to a lighting device.

### BACKGROUND

A light emitting diode (LED) which is placed in a lighting device generates heat so that the temperature of the light emitting diode rises, since electrical energy is converted into thermal energy when current flows. As a result, the light emitting diode becomes in a high temperature state and may cause decrease of brightness or life. A lighting device which is provided with a heat sink of thermally conductive material such as metal so as to dissipate produced heat is known.

However, for example, a down-lighting device is difficult to enhance heat dissipating effect by natural convection, because the down-lighting device needs to be attached to a ceiling etc. and an obstacle such as a ceiling board or a heat insulating member which blocks air flow is arranged around a heat sink.

### BRIEF DESCRIPTION OF THE DRAWINGS

FIG. 1A is a perspective view of a lighting device according to an embodiment and shows a cross-section partially.

FIG. 1B shows a perspective view of the lighting device according to the embodiment with reduction in size.

FIG. 1C is an enlarged perspective view of a heat sink of the lighting device according to the embodiment.

FIG. 2 shows a state of air current in the lighting device according to the embodiment.

FIG. 3 is a perspective view showing another example of the lighting device according to the embodiment.

FIG. 4A is an enlarged perspective view showing another example of the heat sink of the lighting device according to the embodiment.

FIG. 4B is a perspective view of the heat sink of FIG. 4A when seen from a side of a base plate.

FIG. 5A is a perspective view of further another example of the heat sink of the lighting device according to the embodiment and shows a cross-section partially.

FIG. 5B is a perspective view of the heat sink of FIG. 5A when seen from a side of a base plate.

FIG. 6 is a perspective view showing further another example of the lighting device according to the embodiment.

FIG. 7 is a perspective view showing yet another example of the heat sink of the lighting device according to the embodiment.

FIG. 8 is a perspective view showing yet another example of the lighting device according to the embodiment.

### DETAILED DESCRIPTION

A heat sink according to an embodiment includes a base plate having cutting portions, and a heat dissipating fin which is provided perpendicularly to a principal plane of the base plate and is a member having a sectional shape in a direction horizontal to the principal plane of the base plate. The sectional shape is constant substantially in a perpendicular direction.

A lighting device according to an embodiment includes a heat sink and a light emitting unit. The heat sink is provided with a base plate having cutting portions, and a heat dissipating fin which is provided perpendicularly to a principal plane of the base plate and is a member having a sectional shape in a direction horizontal to the principal plane of the base plate. The sectional shape is constant substantially in a perpendicular direction. The light emitting unit is provided on a surface of the base plate opposite to another surface of the base plate on which the heat dissipating fin is arranged.

Hereinafter, further embodiments will be described with reference to the drawings. In the drawings, the same reference numerals denote the same or similar portions respectively.

The drawings are schematic or conceptual, and a relation between a thickness and a width of each part, a size ratio of parts etc. are not necessarily the same as actual ones. Even when the same parts are illustrated, different dimensions or different ratios may be expressed depending on drawings.

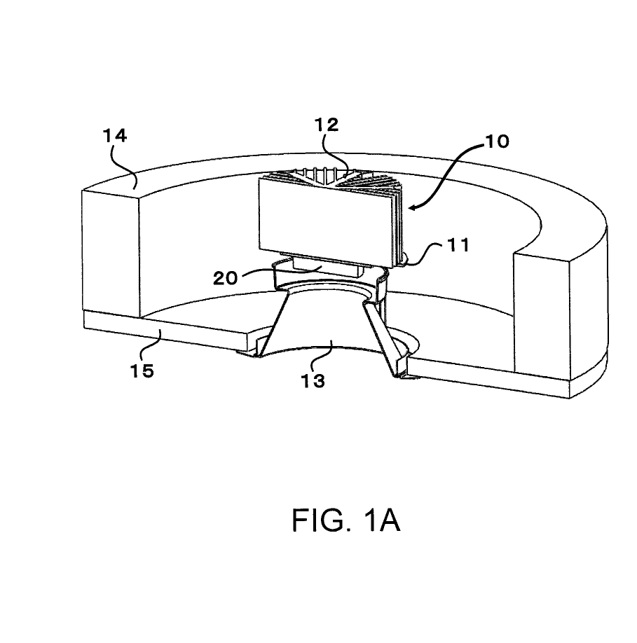

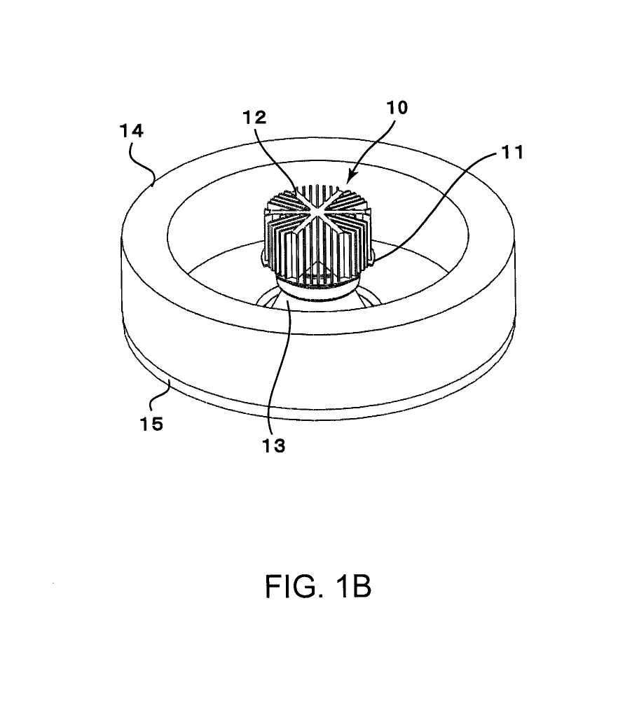

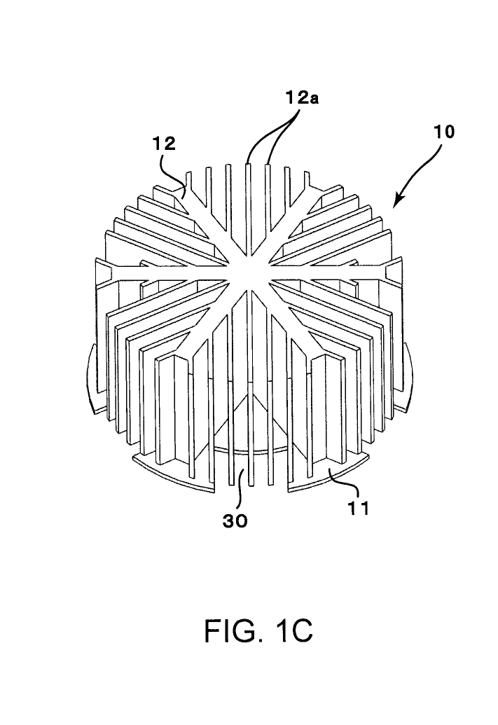

A heat sink and a lighting device according to an embodiment will be described with reference to FIGS. 1A to 1C. FIG. 1A is a perspective view of a lighting device according to an embodiment and shows a cross-section partially. FIG. 1B shows a perspective view of the lighting device according to the embodiment with reduction in size. FIG. 1C is an enlarged perspective view of a heat sink of the lighting device.

As shown in FIGS. 1A and 1B, the lighting device according to the embodiment is provided with a heat sink 10, a light emitting unit 20 and an optical element portion 13. In FIGS. 1A and 1B, the light emitting unit 20 is arranged above the optical element portion 13, and the heat sink 10 is arranged on and above the light emitting unit 20. The heat sink 10 has a base plate 11 and a heat dissipating fin 12 as shown in FIG. 1C. The lighting device can be inserted into and fixed to a ceiling board 15 and can radiate light downward with the attachment.

The base plate 11 can be formed by stamping out with a die or cutting using a material with high thermal conductivity such as an aluminum alloy or a copper, for example. A thermal insulating material 14 is provided to surround the base plate 11, the heat sink 10, the light emitting unit 20 and the optical element portion 13 with a distance from the base plate 11, the heat sink 10, the light emitting unit 20 and the optical element portion 13. The thermal insulating material 14 is fixed to the ceiling board 15.

The base plate 11 has a plurality of cutting portions 30. The cutting portions 30 are formed at plural locations desirably. The cutting portions 30 are arranged to surround the light emitting unit 20 when the light emitting unit 20 is seen from a side of the heat sink 10.

The plurality of cutting portions can be arranged radially and on a circle substantially centered at a center of the base plate 11, for example. By arranging the cutting portions 30 in this way, heat generated from the light emitting unit 20 can be radiated uniformly and efficiently. The cutting portions 30 may be formed simultaneously when the base plate 11 is formed by stamping out with a die, or may be formed by cutting in a post-processing. The cutting portions 30 may have cut and raised portions 19 as described below.

The heat dissipating fin 12 is provided perpendicularly to a principal plane of the base plate 11 and is a member having a sectional shape in a direction horizontal to the principal plane of the base plate. The sectional shape is constant substantially in a perpendicular direction. The heat dissipating fin 12 can be formed by extrusion or stamping out with a die, for example, using a material with high thermal conductivity such as aluminum alloy. The heat dissipating fin 12 can be a radial member composed of a plurality of fin portions 12a which are directed from the center of the base plate 11 to the circumference of the base plate 11 and, with the configuration heat generated from the light emitting unit 20 can be diffused uniformly, efficiently. The shape of the heat dissipating fin 12 is radial, but the invention is not limited to the configuration and the shape of the heat dissipating fin 12 may be a shape composed of a lot of flat plates or a lot of pins. In order to connect the base plate 11 and the heat dissipating fin 12, methods such as screwing, soldering and brazing and other methods by which thermal connection is obtained can be used.

The light emitting unit 20 is provided on a surface of the base plate opposite to another surface of the base plate on which the heat dissipating fin 12 is arranged. The light emitting unit 20 has at least one light emitting element which is arranged in a housing formed of resin, metal or ceramics, for example. A light emitting diode or a laser diode may be used for the light emitting element. The light emitting unit 20 is not limited to the configuration that the at least one light emitting element is provided in the housing, but can also be a simplified unit having a substrate and a light emitting element.

The optical element portion 13 may be a cylindrical member formed of metal such as aluminum or resin. The optical element portion 13 is provided in a direction in which the light emitting unit 20 radiates light, so as to control a light radiated from the light emitting unit 20, for example, so as to reflect the light. A paint which increases reflecting rate may be applied on an inner surface of the cylindrical member constituting the optical element portion 13 so that the light is suppressed to be absorbed in the optical element portion 13 and light emission efficiency is increased.

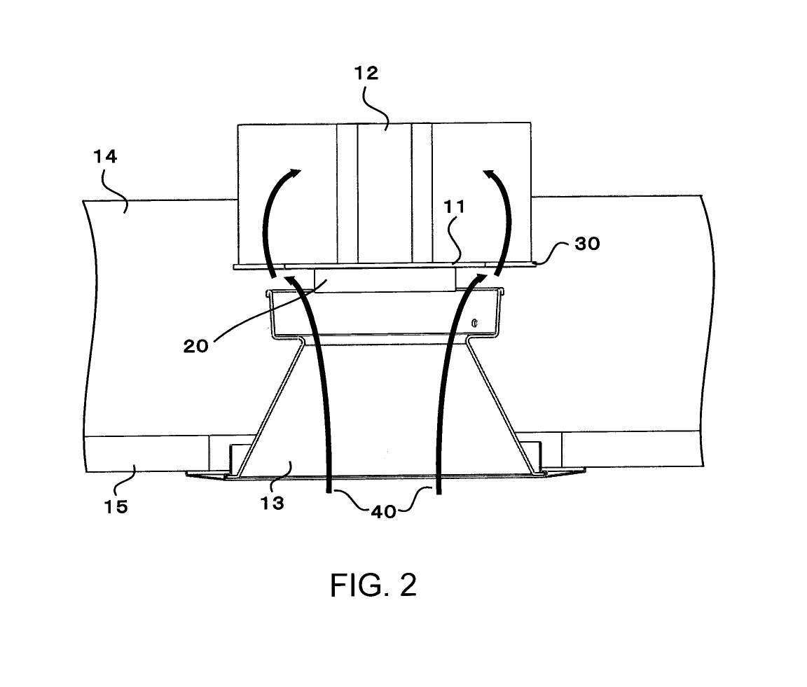

FIG. 2 shows a state of air current in the lighting device according to the embodiment. As shown in FIG. 2, heat can be dissipated efficiently by guiding air flowing from the optical element portion 13 through the cutting portions 30 formed in the base plate 11 to interspaces of heat dissipating fin 12, even if the lighting device is attached to a ceiling board 15, is surrounded by obstacles such as the thermal insulating member 14, and is in an environment in which air flow 40 is restricted. The shape of the cutting portions 30 is not limited to that sown in FIG. 1C, but can be changed according to the shape of the heat dissipating fin 12 or the placing area of the light emitting unit 20.

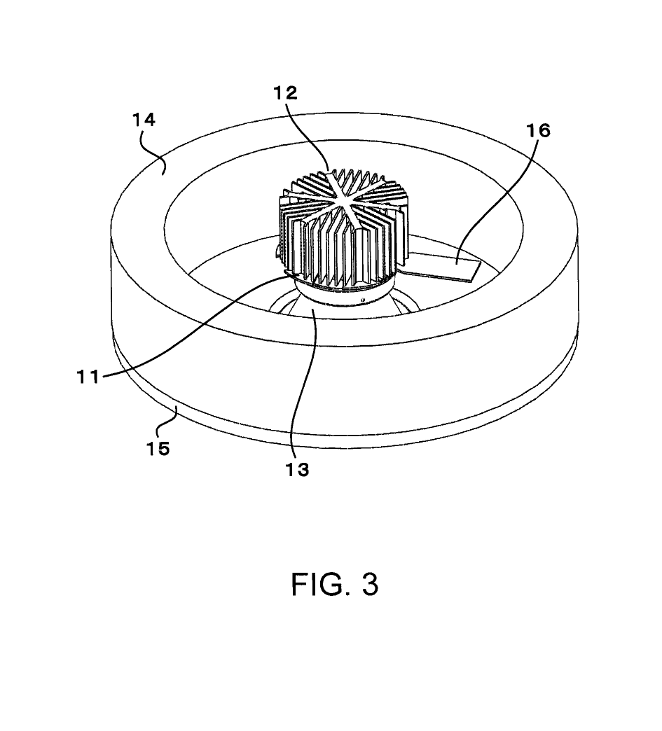

As shown in FIG. 3, at least one portion of an end portion of the base plate 11 may be projected greatly in a horizontal direction than the outside diameter of the lighting device. With this configuration, a heat dissipating area can be broadened without enlarging the heat dissipating fin 12, since the dissipating area is increased by a projecting portion 16.

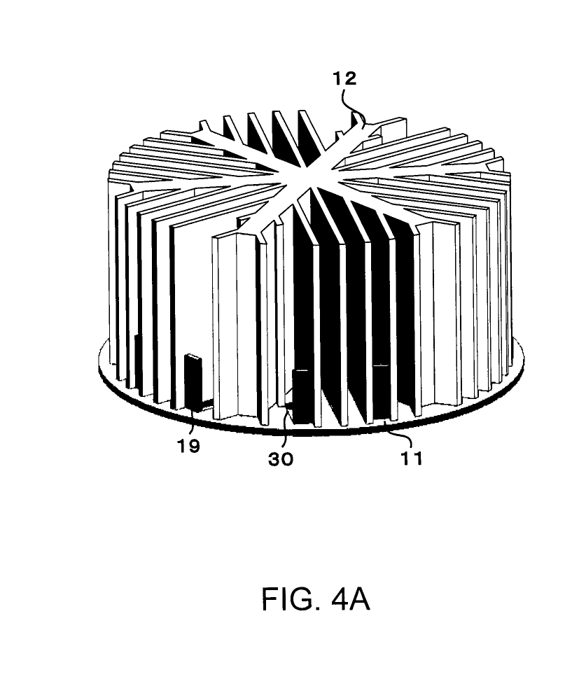

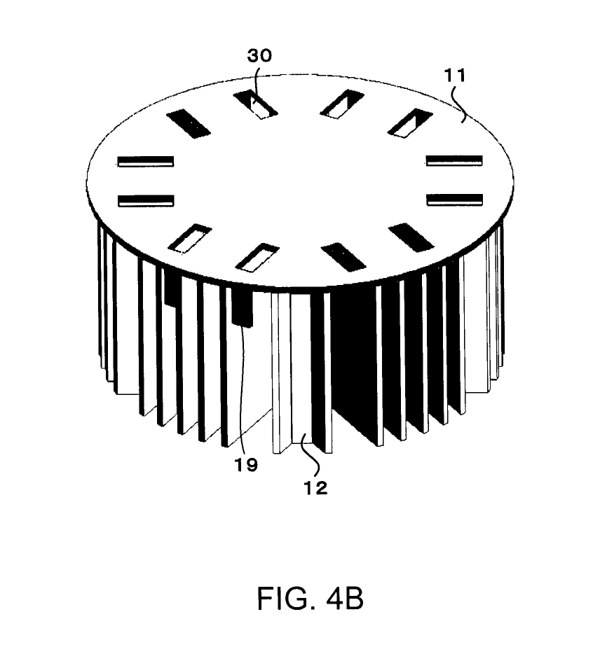

As shown in FIGS. 4A and 4B, when the cutting portions 30 of the base plate 11 are formed, portions of the base plate 11 corresponding to the cutting portions 30 can be cut and raised in a direction in which the heat dissipating fin 12 is arranged. With the cutting and raising, cut and raised portions 19 are provided at the cutting portions 30. According to the configuration shown in FIGS. 4A and 4B, the cut and raised portions 19 can fix the heat dissipating fin 12 so that the cut and raised portions 19 play a role of positioning when the base plate 11 and the heat dissipating fin 12 are joined. The cut and raised portions 19 themselves have a function of a heat dissipating fin and play a role of a rectifying plate for guiding air between the interspaces of the heat dissipating fin 12, which enables enhancing heat dissipating performance.

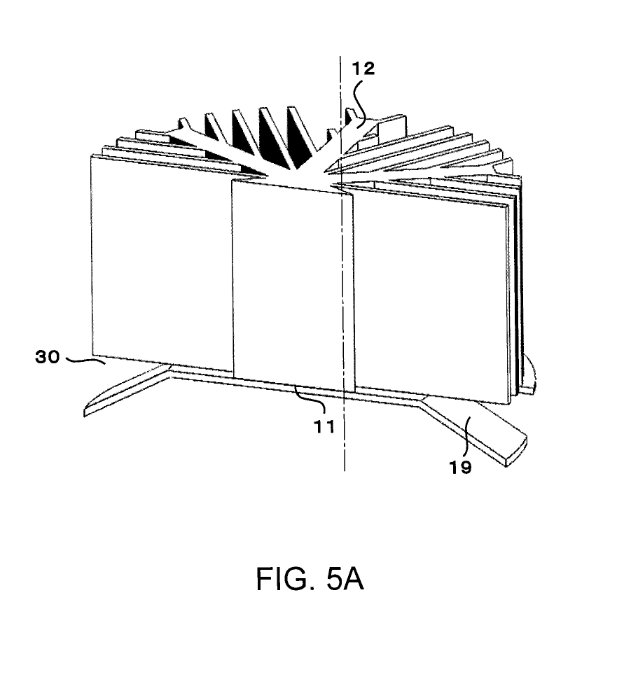

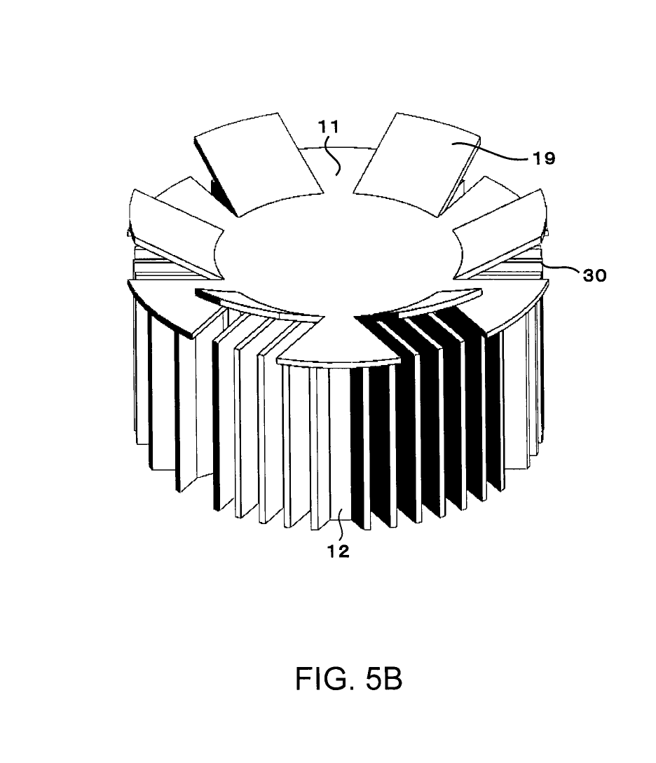

As shown in FIGS. 5A and 5B, when the cutting portions 30 of the base plate 11 are formed, portions of the base plate 11 corresponding to the cutting portions 30 can be cut and raised in a direction in which the light emitting unit 20 is arranged. With the cutting and raising, cut and raised portions 19 are provided at the cutting portions 30. According to the configuration shown in FIGS. 5A and 5B, the cut and raised portions 19 can fix the heat dissipating fin 12 so that the cut and raised portions 19 of the base plate 11 play a role of a heat dissipating fin, which enables enhancing heat dissipating performance. The shapes of the cut and raised portions 19 are not limited to those shown in FIGS. 5A and 5B and can be changed within a range which does not obstruct attachment of a lighting device.

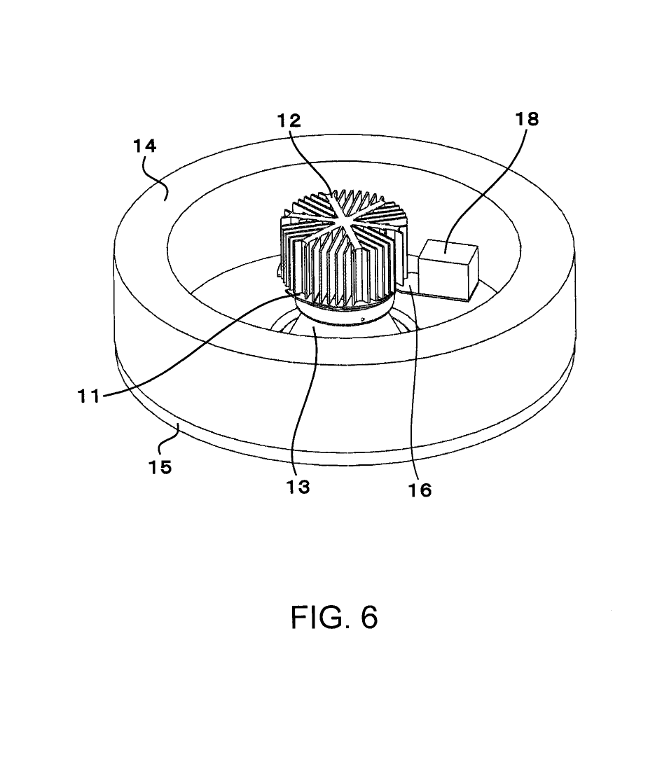

As shown in FIG. 6, a control portion 18 which supplies lighting electric power to the light emitting unit 20 can be arranged on a projecting portion 16 projected from the base plate 11 mentioned above can be arranged. By arranging the light emitting unit 20 at the projecting portion 16, installing work of the control portion 18 can be simplified and also heat produced by a circuit loss of the control portion 18 can be dissipated by the heat sink.

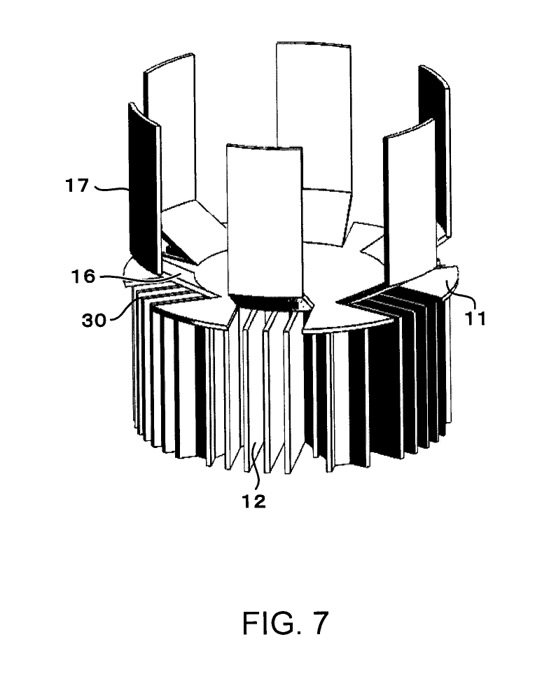

As shown in FIG. 7, projecting portions 16 can be provided at the base plate 11, and can be bent to a side of the light emitting unit 20 shown in FIG. 1A or 2, for example, so as to form bent portions 17. The bent portions 17 can mechanically connect and contact with the optical element portion 13. Using the configuration of FIG. 7, in the lighting device according to the embodiment, the number of members for supporting the optical element portion 13 can be reduced, and also heat dissipating effect can be enhanced more since the heat dissipating area of the lighting device can be enlarged by causing heat transfer to the optical element portion 13.

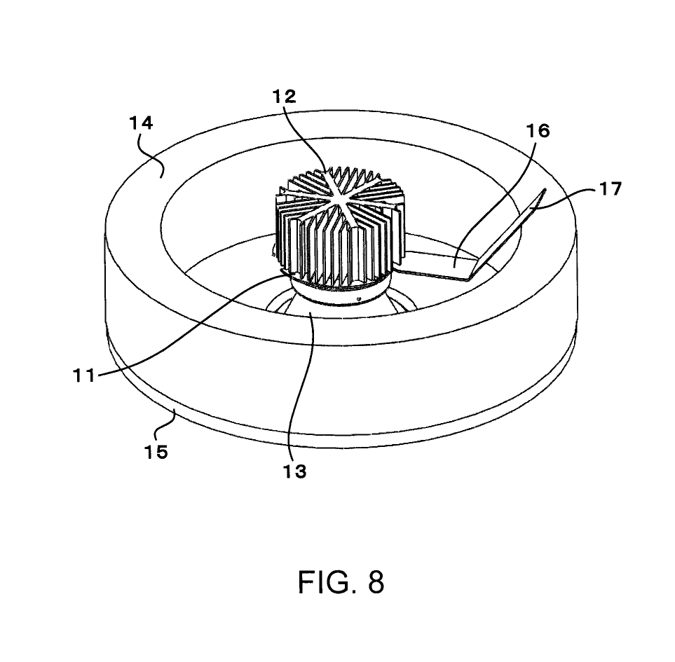

As shown in FIG. 8, a projecting portion 16 can be provided at the base plate 11. The projecting portion 16 can be bent so as to form a bent portion 17. The shape of the bent portion 17 is not limited to that shown in FIG. 8, but can be changed within a range which does not obstruct attachment of the lighting device. With the change, the heat dissipating area of a heat sink can be enlarged even in a limited space.

As described above, according to the heat sink and the lighting device according to the embodiment, sufficient heat dissipation can be realized without enlarging a heat sink even in an environment where flow of air is restricted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A heat sink, comprising:
a base plate having cutting portions; and
a heat dissipating fin which is provided perpendicularly to a principal plane of the base plate and is a member having a sectional shape in a direction horizontal to the principal plane of the base plate, the sectional shape being constant substantially in a perpendicular direction.

2. The heat sink according to claim 1, wherein the heat dissipating fin is a radial member composed of a plurality of fin portions which are directed from a center to the circumference of the base plate.

3. The heat sink according to claim 1, wherein the cutting portions are arranged radially to form a circle substantially.

4. The heat sink according to claim 1, wherein the base plate comprises a projecting portion which is formed by projecting at least part of the base plate.

5. The heat sink according to claim 4, wherein the projecting portion of the base plate has a bent portion.

6. The heat sink according to claim 1, wherein cut and raised portions are provided at the cutting portions respectively.

7. The heat sink according to claim 6, wherein the cut and raised portions are provided on a surface of the base plate on a side of the heat dissipating fin.

8. The heat sink according to claim 6, wherein the cut and raised portions are provided on a surface of the base plate on a side opposite to the heat dissipating fin.

9. The heat sink according to claim 2, wherein the cutting portions are arranged radially and form a circle substantially.

10. A lighting device, comprising:
the heat sink according to claim 1; and
a light emitting unit provided on a surface of the base plate opposite to another surface of the base plate on which the heat dissipating fin is arranged.

11. The lighting device according to claim 10, wherein the cutting portions are arranged to surround the light emitting unit when a side of the light emitting unit is seen from a side of the heat sink.

12. The lighting device according to claim 10, further comprising an optical element portion for reflecting light emitted from the light emitting unit, wherein an end portion of the base plate projects from the external form of the optical element portion.

13. The lighting device according to claim 10, further comprising an optical element portion for reflecting light emitted from the light emitting unit, wherein the base plate has a bent portion which is a part of the base plate projecting and bending, and the bent portion and the optical element portion contact with each other.

14. The lighting device according to claim 12, further comprising a control portion which supplies electric power to the light emitting unit, wherein the control portion is provided at the projected end portion of the base plate.

15. The lighting device according to claim 11, further comprising an optical element portion for reflecting light emitted from the light emitting unit, wherein an end portion of the base plate projects from the external form of the optical element portion.

16. The lighting device according to claim 11, further comprising an optical element portion for reflecting light emitted from the light emitting unit, wherein the base plate has a bent portion which is a part of the base plate projecting and bending, and the bent portion and the optical element portion contact with each other.

17. The lighting device according to claim 15, further comprising a control portion which supplies electric power to the light emitting unit, wherein the control portion is provided at the projected end portion of the base plate.
